(19) United States
(12) Patent Application Publication
(10) Pub. No.: US 2013/0222481 A1
(43) Pub. Date: Aug. 29, 2013

(54) INKJET HEAD AND METHOD OF MANUFACTURING THE SAME

(71) Applicants: Shuhei Yokoyama, Shizuoka-ken (JP); Ryutaro Kusunoki, Shizuoka-ken (JP); Chiaki Tanuma, Tokyo (JP); Ryuichi Arai, Shizuoka-ken (JP)

(72) Inventors: Shuhei Yokoyama, Shizuoka-ken (JP); Ryutaro Kusunoki, Shizuoka-ken (JP); Chiaki Tanuma, Tokyo (JP); Ryuichi Arai, Shizuoka-ken (JP)

(73) Assignee: TOSHIBA TEC KABUSHIKI KAISHA, Tokyo (JP)

(21) Appl. No.: 13/412,755

(22) Filed: Mar. 6, 2012

(30) Foreign Application Priority Data
Feb. 27, 2012 (JP) 2012-39615

(51) Int. Cl. B41J 2/16; B23P 17/00

(52) U.S. Cl. 347/47; 29/890.1

(57) ABSTRACT

An inkjet head includes a nozzle plate in which a nozzle having an ejection hole for ink is formed, an ink pressure chamber for supplying the ink to the nozzle, a first oscillating plate formed to surround the ejection hole of the nozzle of the nozzle plate, a first electrode formed to surround the nozzle of the nozzle plate and that is in contact with the first oscillating plate, a piezoelectric film configured to surround the nozzle of the nozzle plate and that is in contact with the first electrode, a second electrode formed to surround the nozzle of the nozzle plate and that is in contact with the piezoelectric film or the first oscillating plate, and a second oscillating plate formed to surround the nozzle of the nozzle plate and that is in contact with the first electrode, the second electrode, or the first oscillating plate.

### CROSS-REFERENCE TO RELATED APPLICATION

This application is based upon and claims the benefit of priority from the prior Japanese Patent Application No. 2012-39615 filed on Feb. 27, 2012, the entire contents of which are incorporated herein by reference.

### FIELD

Embodiments described herein relate generally to an inkjet head that ejects ink from nozzles and forms an image on recording media and a method of manufacturing the inkjet head.

### BACKGROUND

There is known an on-demand type inkjet recording system for ejecting ink droplets from nozzles according to an image signal and forming an image by the ink droplets on recording paper. The on-demand type inkjet recording system mainly includes a heat generating element type and a piezoelectric element type. The heat generating element type is configured to energize a heat generating body provided in an ink channel to generate air bubbles in ink and eject the ink pushed by the air bubbles from nozzles. The piezoelectric element type is configured to eject ink stored in an ink chamber from nozzles making use of deformation of a piezoelectric element.

The piezoelectric element is an element that converts a voltage into force. When an electric field is applied to the piezoelectric element, the piezoelectric element causes extension or shear deformation. As a representative piezoelectric element, lead zirconate titanate is used.

As an inkjet head that makes use of the piezoelectric element, a configuration including a nozzle board formed of a piezoelectric material is known. In this inkjet head, electrodes are formed on both surfaces of the piezoelectric nozzle board to surround nozzles that eject ink. The ink enters between the nozzle board and a substrate that supports the nozzle board. The ink forms meniscuses in the nozzles and is maintained in the nozzles. When a driving waveform for oscillating the piezoelectric element is applied to the electrodes of the nozzle board, the piezoelectric element around the nozzles oscillates. The piezoelectric element oscillates to thereby cause ultrasonic oscillation in the nozzles. The ink in the meniscuses is ejected.

### DESCRIPTION OF THE DRAWINGS

FIG. 1 is a disassembled perspective view of an inkjet head according to a first embodiment (ink in an ink supply path 402 does not circulate);

FIG. 2 is a disassembled perspective view of the inkjet head according to the first embodiment (the ink in the ink supply path 402 circulates);

FIG. 3 is a plan view of the inkjet head according to the first embodiment;

FIGS. 4(a) to 4(d) are diagrams for explaining a manufacturing process for the inkjet head according to the first embodiment;

FIGS. 5(e) to 5(h) are diagrams for explaining a manufacturing process for the inkjet head following the manufacturing process shown in FIGS. 4(a) to 4(d) in the first embodiment;

FIGS. 6(i) to 6(k) are diagrams for explaining a manufacturing process for an inkjet head following the manufacturing process shown in FIGS. 5(e) to 5(h) in the first embodiment;

FIGS. 7(l) and 7(m) are diagrams for explaining a manufacturing process for the inkjet head following the manufacturing process shown in FIGS. 6(i) to 6(k) in the first embodiment;

FIG. 8 is a B-B′ sectional view of the inkjet head according to the first embodiment;

FIG. 9 is a C-C′ sectional view of the inkjet head according to the first embodiment;

FIG. 10 is a plan view of an inkjet head according to a second embodiment; and

FIG. 11 is a plan view of an inkjet head according to a third embodiment.

### DETAILED DESCRIPTION

According to an embodiment, an inkjet head includes a nozzle plate in which a nozzle having an ejection hole for ink is formed. An ink pressure chamber supplies the ink to the nozzle. A first oscillating plate formed to surround the ejection hole of the nozzle of the nozzle plate. A first electrode formed to surround the nozzle of the nozzle plate, the first electrode can be in contact with the first oscillating plate. A piezoelectric film configured to surround the nozzle of the nozzle plate, the piezoelectric film can be in contact with the first electrode. A second electrode formed to surround the nozzle of the nozzle plate, the second electrode can be in contact with the piezoelectric film or the first oscillating plate. A second oscillating plate formed to surround the nozzle of the nozzle plate, the second oscillating plate can be in contact with the first electrode, the second electrode, or the first oscillating plate.

Embodiments are explained below with reference to the accompanying drawings.

### First Embodiment

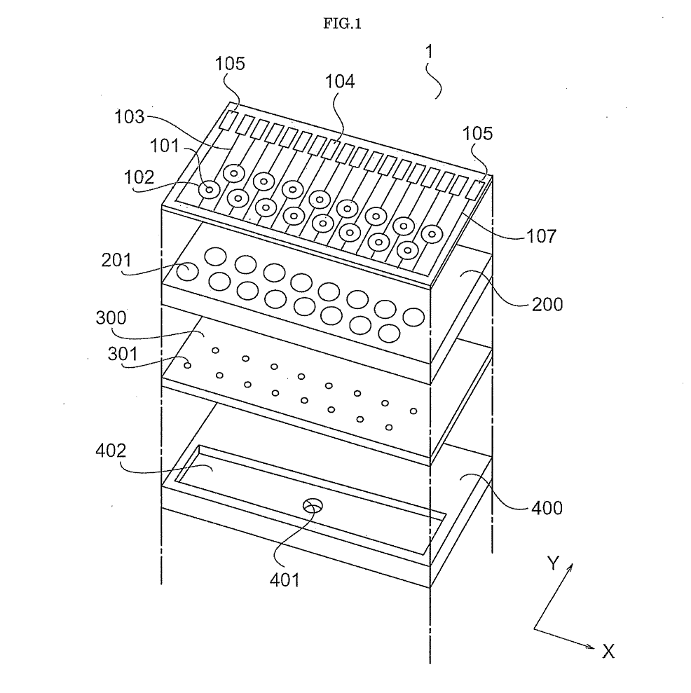

FIG. 1 is a disassembled perspective view of an inkjet head according to a first embodiment.

The inkjet head 1 shown in FIG. 1 includes a nozzle plate 100, a ink pressure chamber structure 200, a separate plate 300, and a ink supply path structure 400.

The nozzle plate 100 includes plural nozzles 101 for ink ejection (ink ejection holes) that pierce through the nozzle plate 100 in the thickness direction thereof.

The ink pressure chamber structure 200 includes plural ink pressure chambers 201 corresponding to the plural nozzles 101. One ink pressure chamber 201 is connected to nozzle 101 corresponding thereto.

The separate plate 300 includes ink chokes 301 (openings for ink supply to the ink pressure chambers) connected to the ink pressure chambers 201 formed in the ink pressure chamber structure 200.

The ink pressure chambers 201 and the ink chokes 301 are provided to correspond to the plural nozzles 101. The plural ink pressure chambers 201 are connected to an ink supply path 402 through the ink chokes 301.

The ink pressure chambers 201 store ink for image formation. A pressure change occurs in the ink contained in the ink pressure chambers 201 according to deformation of the nozzle plate 100 and the ink is ejected from the nozzles 101. At this point, the separate plate 300 plays a role for confining pressure generated in the ink pressure chambers 201 and preventing the pressure from escaping to the ink supply path 402. Therefore, the diameter of the ink chokes 301 is equal to or smaller than a quarter of the diameter of the ink pressure chambers 201.

The ink supply path 402 is provided in the ink supply path structure 400. An ink supply port 401 for supplying the ink from the outside of the inkjet head 1 is provided in the ink supply path structure 400. The ink supply path 402 surrounds all the plural ink pressure chambers 201 such that the ink can be supplied to all the ink pressure chambers 201.

The ink pressure chamber structure 200 is made, for example, of a silicon wafer having thickness of 725 μm. The ink pressure chambers 201 can have, for example, a cylindrical shape having a diameter of 240 μm. The nozzles 101 are provided in the centers of circles of the ink pressure chambers 201.

The separate plate 300 is made, for example, of stainless steel having thickness of 200 μm. The diameter of the ink chokes 301 can for instance be set to 100 μm. The ink chokes 301 are made to suppress shape fluctuations of the ink chokes 301 such that ink channel resistances to the respective ink pressure chambers 201 are substantially the same.

The ink supply path structure 400 is made, for example, of stainless steel having thickness of 4 mm. The ink supply path 402 is provided at depth of 2 mm from the surface of the stainless steel. The ink supply port 401 is provided in substantially the center of the ink supply path 402. The ink supply port 401 is made such that ink channel resistances to the ink pressure chambers 201 are substantially the same.

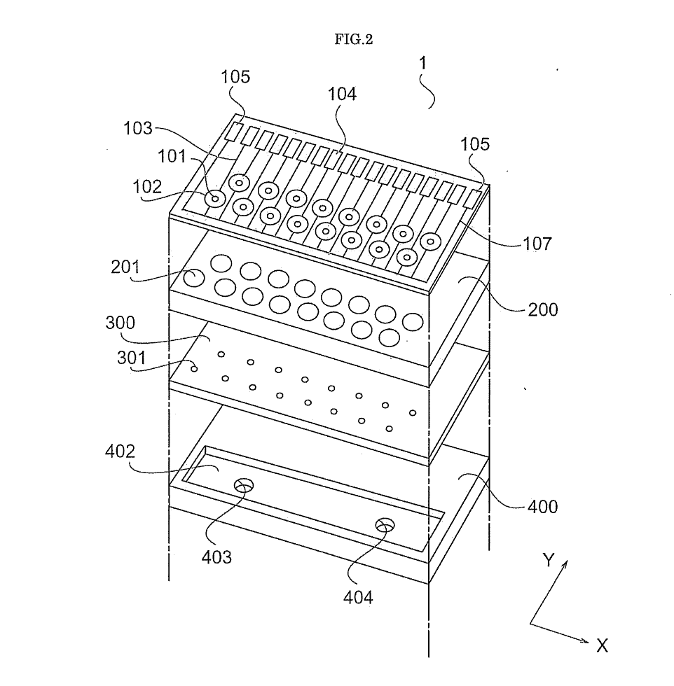

In FIG. 2, unlike FIG. 1, a circulating ink supply port 403 and a circulating ink discharge port 404 are arranged near both ends of the ink supply path 402 such that the ink is circulated in the ink supply path 402.

Since the ink circulates, ink temperature in the ink supply path 402 can be kept constant. Therefore, compared with the inkjet head shown in FIG. 1, there is an effect that a temperature rise in the inkjet head due to heat generated by deformation of the nozzle plate 100 is suppressed.

The nozzle plate 100 has an integral structure in which the nozzle plate 100 is formed on the ink pressure chamber structure 200 in a film forming process explained later.

The ink pressure chamber structure 200, the separate plate 300, and the ink supply path structure 400 are fixed, for example, by epoxy adhesive such that the nozzles 101 and the ink pressure chambers 201 keeps a predetermined positional relation.

The ink pressure chamber structure 200 can be made of a silicon wafer and the separate plate 300 and the ink supply path structure 400 can be made of stainless steel, for example. However, the materials of the structures 200, 300, and 400 are not limited to the silicon wafer and stainless steel. The structures 200, 300, and 400 are also possible to use other materials taking into account differences between coefficients of expansion of the materials and the coefficient of expansion of the nozzle plate 100 as long as the materials do not affect the generation of ink ejection pressure. For example, a ceramic material, alumina ceramics, zirconia, silicon carbide, and nitrides and oxides such as silicon nitride and barium titanate can also be used. A resin material, plastic materials such as ABS (acrylonitrile butadiene styrene), polyacetal, polyamide, polycarbonate, and polyether sulfone can also be used. A metal material (alloy) can also be used. Representative metal materials can include aluminum and titanium and their respective alloys.

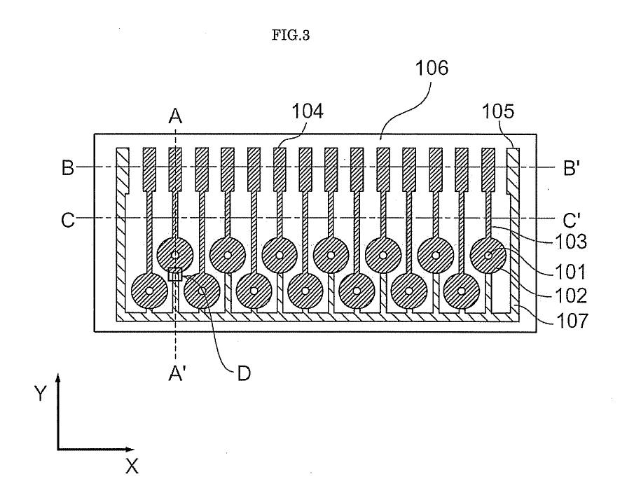

The configuration of the nozzle plate 100 is further explained with reference to FIG. 3. FIG. 3 is a plan view of the nozzle plate 100 viewed from the ink ejection side.

The nozzle plate 100 includes the nozzles 101 configured to eject the ink and actuators 102 configured to generate pressure for ejecting the ink from the nozzles 101. The nozzle plate 100 includes wiring electrodes 103 and a shared electrode 107 that transmit signals for driving the actuators 102. Further, the nozzle plate 100 includes wiring electrode terminal sections 104 that are a part of the wiring electrodes 103 and configured to receive a signal for driving the inkjet head 1 from the outside of the inkjet head 1 and shared electrode terminal sections 105 that are a part of the shared electrode 107 and configured to receive a signal for driving the inkjet head 1.

The actuators 102, the wiring electrodes 103, the wiring electrode terminal sections 104, the shared electrode 107, and the shared electrode terminal sections 105 are formed on a second oscillating plate 106.

The nozzles 101 pierce through the nozzle plate 100. The center of the circular section of one ink pressure chamber 201 and the center of the nozzle 101 that corresponds with the ink pressure chamber 201 coincide with each other. The ink is supplied from one ink pressure chamber 201 into a corresponding nozzle 101. The second oscillating plate 106 is deformed by the operation of the actuator 102 corresponding to the nozzle 101. The ink supplied to the nozzle 101 is ejected by a pressure change caused in the ink pressure chamber 201. All the nozzles 101 perform the same operation.

The nozzles 101 can, for example, have a cylindrical shape and a diameter of 20 μm.

The actuators 102 can be formed of piezoelectric films, for example. Each of the actuators 102 operates using the piezoelectric film and two electrodes (the wiring electrode 103 and the shared electrode 107) that hold the piezoelectric film. When the piezoelectric film is formed, polarization occurs in the thickness direction of the piezoelectric film. If an electric field in a direction that is the same as the direction of the polarization is applied to the piezoelectric film via the electrodes, the actuator 102 expands and contracts in a direction orthogonal to the electric field direction. The second oscillating plate 106 is deformed making use of this expansion and contraction and causes a pressure change in the ink contained in the ink pressure chamber 201. The shape of the piezoelectric film can be circular. The piezoelectric film is present in a circle concentric with the ejection side opening of the nozzle 101. The diameter of the circular piezoelectric film can be set, for example, to 170 μm. In other words, the piezoelectric film surrounds the ejection side opening of the nozzle 101.

The actuators 102, in centers of which the nozzles 101 are arranged, include the piezoelectric films having a diameter of 170 μm. Therefore, the actuators 102 can be arranged in zigzag (alternately) pattern in order to arrange the nozzles 101 at higher density. The plural nozzles 101 are arranged linearly in an X axis direction of FIG. 3. Two liner nozzle rows are provided in a Y axis direction. The distance between the centers of the nozzles 101 adjacent in the X axis direction can be set to 340 μm, for example. An arrangement interval of two rows of the nozzles 101 can be set to 240 μm in the Y axis direction, for instance. By arranging the nozzles 101 in this way, the wiring electrodes 103 can be formed to pass between two actuators 102 in the X axis direction.

A material that can be used for the piezoelectric film can include PZT (lead zirconate titanate). Other materials that can also be used include PTO (PbTiO₃: lead titanate), PMNT (Pb(Mg_{1/3}Nb_{2/3})O₃—PbTiO₃), PZNT (Pb(Zn_{1/3}Nb_{2/3})O₃—PbTiO₃), ZnO, AlN, and the like.

The piezoelectric film can be formed at substrate temperature of 350° C. by an RF magnetron sputtering method. The thickness of the piezoelectric film, for example, can be set to 1 μm. After the piezoelectric film formation, in order to give piezoelectric properties to the piezoelectric film, heat treatment can, for example, be performed for three hours at 500° C. Consequently, satisfactory piezoelectric performance can be obtained. Other manufacturing methods for forming the piezoelectric film can include a CVD (a chemical vapor deposition method), a sol-gel method, an AD method (an aero-sol deposition method), a hydrothermal synthesis method, and the like. The thickness of the piezoelectric film is determined according to a piezoelectric characteristic, a dielectric breakdown voltage, and the like. The thickness of the piezoelectric film is generally in a range from less than or equal to 0.1 μm to greater than or equal to 5 μm.

The plural wiring electrodes 103 are one of two electrodes connected to the piezoelectric films of the plural actuators 102. The plural wiring electrodes 103 are formed on the ejection side with respect to the piezoelectric films. Each of the wiring electrodes 103 is separately connected to the piezoelectric film of the actuator 102 corresponding thereto. Each of the wiring electrodes 103 acts as an individual electrode for causing the piezoelectric film to independently operate. Each of the wiring electrodes 103 includes a circular electrode section having a diameter larger than that of the circular piezoelectric film, a wiring section, and the wiring electrode terminal section 104. The nozzle 101 is formed in the center of the circular electrode section. Therefore, the section without the wiring electrode film is formed in a shape of a circle concentric with the nozzle 101.

The plural wiring electrodes 103 can be formed, for example, of a Pt (platinum) thin film. For the formation of the thin film, a sputtering method can be used. The thickness of the thin film can be set to 0.5 μm, for example. Other electrode materials that can be employed for the wiring electrodes 103 include Ni (nickel), Cu (copper), Al (aluminum), Ti (titanium), W (tantalum), Mo (molybdenum), Au (gold), and the like. Other film forming methods, such as, vapor deposition and metal plating can also be used. Desirable thicknesses of the plural wiring electrodes 103 range from less than or equal to 0.01 μm to greater than or equal to 1 μm, for example.

The shared electrode 107 is one of the two electrodes connected to the piezoelectric films. The shared electrode 107 can be formed on the ink pressure chamber 201 side with respect to the piezoelectric films. The shared electrode 107 can be connected in common to the piezoelectric films and acts as a common electrode. The shared electrode 107 can include a circular electrode section having a diameter smaller than the circular piezoelectric film, a wiring section formed in a direction opposite to individual electrode wiring sections from the actuators 102 and gathered at both ends in the X axis direction of the nozzle plate 100, and the shared electrode terminal sections 105. Since the nozzle 101 is formed in the center of the circular electrode section, like the wiring electrode films, a section without a shared electrode film is formed in a shape of a circle concentric with the nozzle 101.

The shared electrode 107 can be formed of a Pt (platinum)/Ti (titanium) thin film, for example. For the formation of the thin film, a sputtering method can be used. The thickness of the thin film can be set to 0.5 μm, for example. Other electrode materials for the shared electrode 107 can include Ni, Cu, Al, Ti, W, Mo, Au, and the like. Other film forming methods such as, vapor deposition and metal plating can also be used. Desirable thickness of the shared electrode 107 can range from less than or equal to 0.01 μm to greater than or equal to 1 μm.

The wiring electrode terminal sections 104 and the shared electrode terminal sections 105 are provided in order to receive a signal for driving the actuators 102 from an external driving circuit. Since the wiring electrodes 103 and the shared electrode 107 are wired though spaces among the actuators 102, in this embodiment, the wiring width is about 80 μm.

The shared electrode terminal sections 105 are provided on both sides of the individual wiring terminal sections 104. An interval of the wiring electrode terminal sections 104 is the same as an interval 340 μm in the X axis direction of the plural nozzles 101. Therefore, the width in the X axis direction of the wiring electrode terminal sections 104 can be set large compared with the wiring width of the wiring electrodes 103. This makes it easy to connect the external driving circuit and the wiring electrode terminal sections 104. The wiring electrodes 103 function as individual electrodes configured to drive the actuators 102.

A method of manufacturing this inkjet head is explained with reference to an A-A′ section shown in FIG. 3.

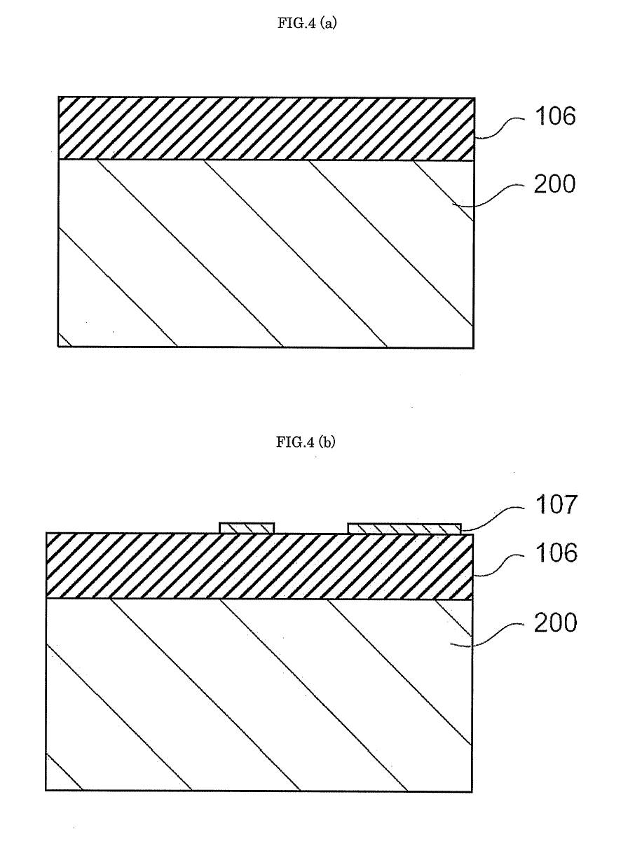

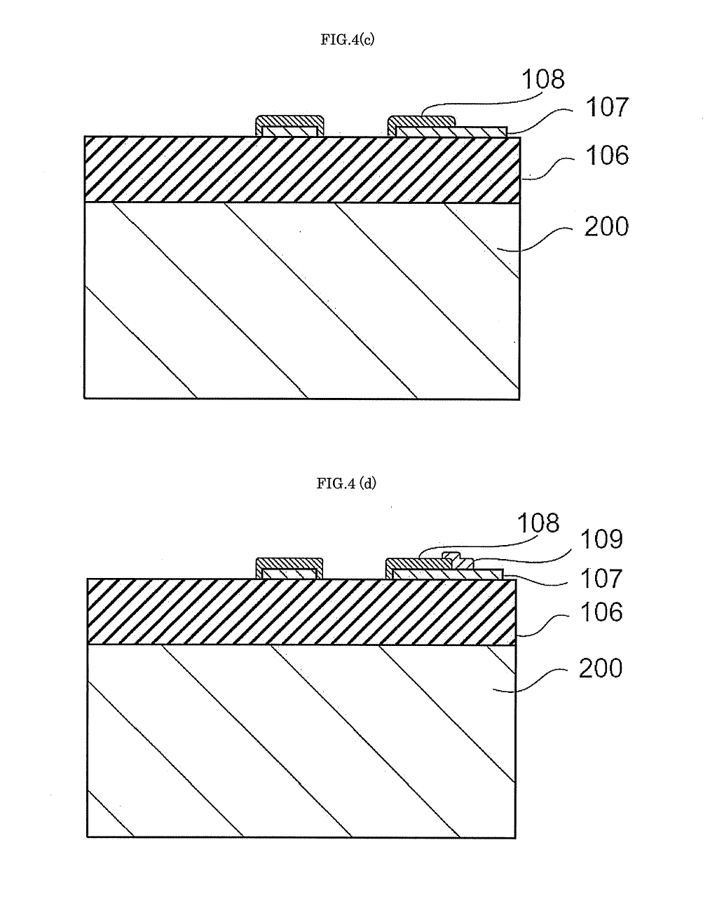

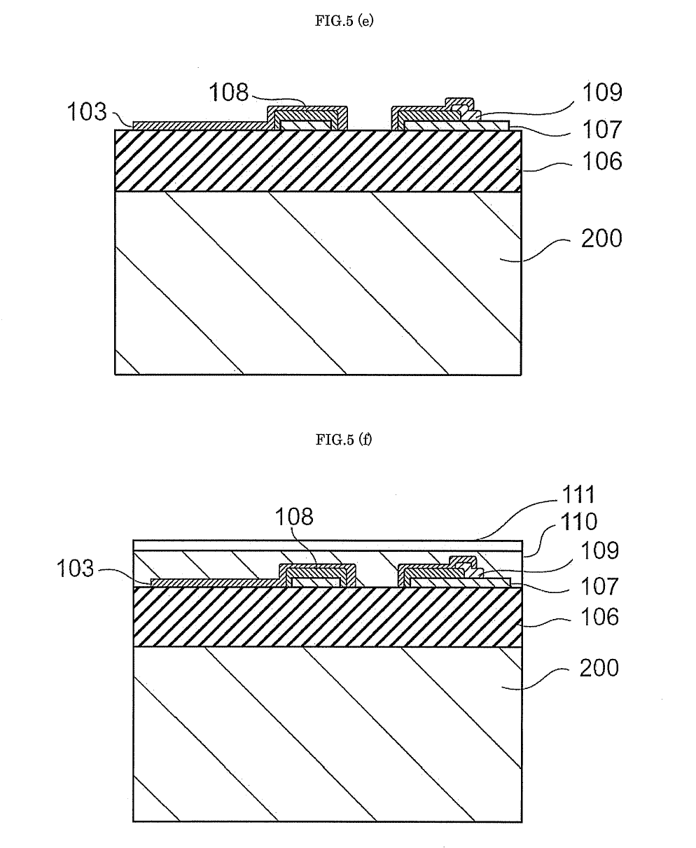

FIGS. 4(a) to 7(m) are diagrams of a manufacturing process of the inkjet head. Materials forming the inkjet head are subjected to film formation by thin filming or spin coating to manufacture the inkjet head.

FIG. 4(a) is a diagram of a configuration in which the second oscillating plate 106 is formed on the ink pressure chamber structure 200. In order to form the nozzle plate 100, a silicon wafer subjected to mirror polishing is used for the ink pressure chamber structure 200. In a process for fabricating the nozzle plate 100, since heating and formation of a thin film is repeated, a silicon wafer having heat resistance is used. The silicon wafer is a smoothed silicon wafer having thickness of 525 μm to 775 μm conforming to the SEMI (Semiconductor Equipment and Materials International) standard. Instead of a silicon wafer, a substrate of ceramics, quartz, or various kinds of metal having heat resistance can also be used.

In regard to the second oscillating plate 106, an SiO₂ film (silicon oxide) formed by the CVD method can be used. A film having thickness of about 6 μm can be formed over the entire surface of the ink pressure chamber structure 200.

The thickness of the second oscillating plate 106 can desirably be in a range from less than or equal to 1 μm to greater than or equal to 50 μm. Instead of SiO₂, SiN (silicon nitride), Al₂O₃ (aluminum oxide), HfO₂ (hafnium oxide), or DLC (Diamond Like Carbon) can also be used. Generally, the material used for the second oscillating plate 106 is selected taking into account heat resistance, insulating properties (when ink having high electric conductivity is used, the influence of ink deterioration due to driving of the actuators 102 is taken into account), a coefficient of thermal expansion, smoothness, and wettability to ink.

In FIG. 4(b), formation of the shared electrode 107 formed on the second oscillating plate 106 is shown. An electrode material can be Pt and Ti. Films of Ti and Pt can be formed in order using a sputtering method. The film thickness of Ti can be set to 0.45 μm, and the film thickness of Pt can be set to 0.05 μm, for example.

After the electrode film is formed, the electrode film can be patterned into a shape suitable for the actuator 102, the wiring section, and the shared electrode terminal section 105 to form the shared electrode 107. The patterning can be performed by forming an etching mask on the electrode film and removing electrode materials excluding the etching mask through an etching process. The etching mask is formed by, after applying a photo resist on the electrode film, performing a pre-bake, exposing the electrode film using a mask on which a desired pattern is formed, and performing a post-bake through a development process.

A section of the shared electrode 107 equivalent to a piezoelectric film 108 is smaller than the outer diameter of the piezoelectric film and is a circular pattern having an outer diameter of 166 μm. Since the nozzle 101 is formed in the center of the circular shared electrode 107, a section having a diameter of 34 μm without an electrode film is formed as a concentric circle from the center of the circular shared electrode 107. Since the shared electrode 107 is patterned, the second oscillating plate 106 is exposed in sections excluding the circular section and the wiring section of the shared electrode 107.

In FIG. 4(c), the piezoelectric film 108 formed on the shared electrode 107 is shown. The piezoelectric film 108 is formed on the shared electrode 107 and the second oscillating plate 106. For example, PZT can be used for the piezoelectric film 108. The piezoelectric film 108 having thickness of 1 μm can be formed by the sputtering method at substrate temperature of 350° C., for instance. In order to give piezoelectric properties to a PZT thin film, heat treatment can be performed for three hours at 500° C. When the PZT thin film is formed, polarization occurs along a film thickness direction from the shared electrode 107.

Patterning of the piezoelectric film 108 can be performed using an etching process. A photo resist can be applied on the piezoelectric film 108. Subsequently, a pre-bake can be performed. Exposure is performed using a mask on which a desired pattern is formed. A post-bake is performed through development and fixing processes to form an etching mask of the photo resist. Etching is performed using this etching mask to obtain the piezoelectric film 108 having a desired shape.

A pattern of the piezoelectric film 108 is a circular shape having an outer diameter of 170 μm. Since the nozzle 101 is formed in the center of the circular pattern, a section having a diameter of 30 μm without a piezoelectric film in a concentric circle is formed from the center of the circular piezoelectric film 108. The second oscillating plate 106 is exposed in the section having the diameter of 30 μm without the piezoelectric film. Since the diameter of the section without the circular piezoelectric film is 30 μm and the diameter of the section without the circular shared electrode 107 is 34 μm, the piezoelectric film 108 is formed to cover the shared electrode 107 included in the actuator 102. Since the piezoelectric film 108 covers the shared electrode 107, insulating properties between the shared electrode 107 and the other wiring electrode 103 for applying a voltage to the piezoelectric film 108 can be secured. In other words, the wiring electrode 103 functioning as an individual electrode for driving the actuator 102 and the shared electrode 107 are insulated by the piezoelectric film 108.

In FIG. 4(d), an insulating film 109 on the piezoelectric film 108 and the shared electrode 107 in a section corresponding to D in FIG. 3 is shown. In order to keep the insulation between the wiring section of the shared electrode 107 and the wiring electrode 103 included in the actuator 102, the insulating film 109 is formed on the surfaces of the piezoelectric film 108 and the shared electrode 107. The thickness of the insulating film 109 can be set to 0.2 μm and the material used for the insulating film 109 can be SiO₂, for example. For the formation of the insulating film 109, a CVD method that can realize satisfactory insulating properties with low-temperature film formation can be used. Since the insulating film 109 has to be formed only on the surfaces of the piezoelectric film 108 and the shared electrode 107, patterning can be performed. After a resist is applied, a pre-bake can be performed, exposure can be performed using a mask of a desired pattern, and a post-bake can be performed through development and fixing processes to form an etching mask. Etching can be performed using this etching mask to obtain a desired insulating thin film. The insulating film 109 can be patterned to cover a part of the piezoelectric film 108 taking into account patterning fluctuation accuracy. An amount of covering of the piezoelectric film 108 by the insulating film 109 can be set to a degree for not hindering a deformation amount of the piezoelectric film 108.

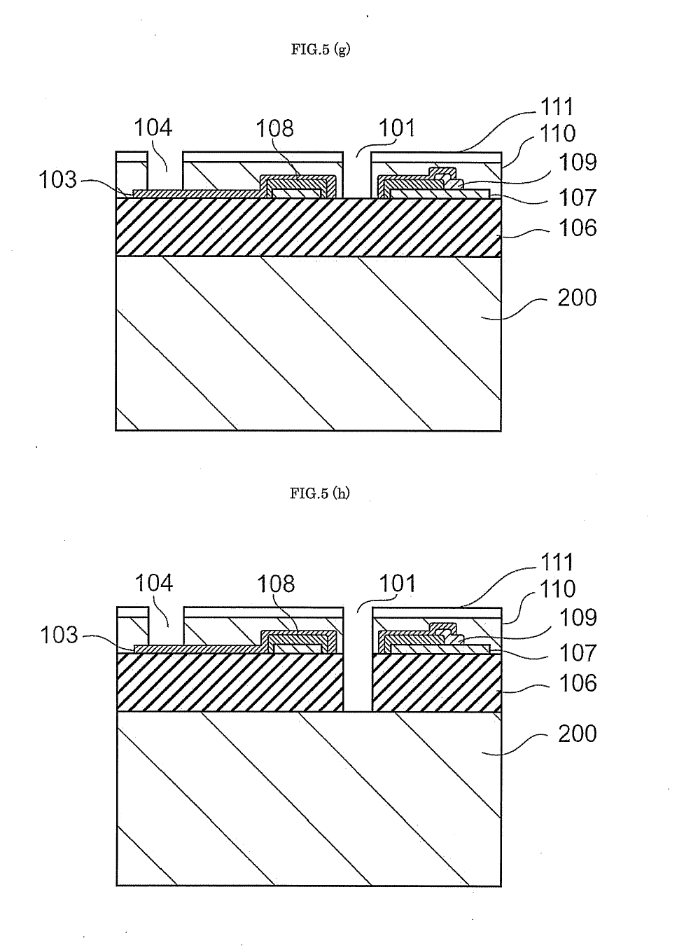

In FIG. 5(e), the wiring electrode 103 formed on the second oscillating plate 106, the piezoelectric film 108, and the insulating film 109 is shown. The wiring electrode 103 can be made of Pt and can have a thickness of 0.5 μm. The wiring electrode 103 can be formed by a sputtering method. After the electrode is formed, an electrode film is patterned into a shape suitable for the actuator 102, the wiring section, and the wiring electrode terminal section 104 to form the wiring electrode 103. The patterning can be performed by forming an etching mask on the electrode film and removing electrode materials excluding the etching mask with etching. The etching mask can be formed by, after applying a photo resist on the electrode film, performing a pre-bake, exposing the electrode film using a mask on which a desired pattern is formed, and performing a post-bake through a development process.

A section of the wiring electrode 103 equivalent to the piezoelectric film 108 is a circular pattern having an outer diameter of about 174 μm. Since the nozzle 101 is formed in the center of the circular wiring electrode 103, a section having a diameter of about 26 μm without an electrode film in a concentric circle is formed from the center of the circular wiring electrode 103. In other words, the wiring electrode 103 included in the actuator 102 is formed in a shape that covers the piezoelectric film 108.

Other film formation materials that can be used for the wiring electrode 103 can include Cu, Al, Ag, Ti, W, Mo, Pt, and Au. Other formation methods that can be used for the wiring electrode 103 include vacuum deposition, metal plating, and the like. The thickness of the wiring electrode 103 can desirably be in the range of 0.01 μm to 1 μm.

In FIG. 5(f), a first oscillating plate 110 and a metal film 111 formed on the second oscillating plate 106, the wiring electrode 103, the shared electrode 107, and the insulating film 109 are shown. The first oscillating plate 110 can be made of polyimide and can have a thickness of 3 μm, for example. The first oscillating plate 110 can be formed by, after forming a film of a solution containing a polyimide precursor with a spin coating method, performing thermal polymerization and solution removal with a bake. By forming the film with the spin coating method, a film having a smooth surface can be formed to cover the actuator 102, the wiring electrode 103, and the shared electrode 107 formed on the second oscillating plate 106.

For the first oscillating plate 110, instead of polyimide, a resin material, plastic materials such as ABS (acrylonitrile butadiene styrene), polyacetal, polyamide, polycarbonate, and polyether sulfone can also be used. Additionally or alternatively, a ceramic material, zirconia, silicon carbide, and nitrides and oxides such as silicon nitride and barium titanate can also be used. Further, a metal material (alloy) can also be used. Representative materials that can be used include materials such as aluminum, SUS, and titanium. As to formation methods, CVD, vacuum deposition, metal plating, and the like can be employed. The thickness of the first oscillating plate 110 can desirably be in the range of about 1 μm to about 50 μm.

Further, in selection of a material for the first oscillating plate 110, the Young's modulus of the material can be substantially different from that of the material used for the second oscillating plate 106. In other words, the material of the first oscillating plate 110 is desirably a material, the Young's modulus of which is substantially different from the Young's modulus of the second oscillating plate 106 and the Young's modulus of the first oscillating plate 110. A deformation amount of a plate shape is affected by its Young's modulus and the plate thickness of the plate material. Even if the same force is applied, deformation is larger as the Young's modulus is smaller and the plate thickness is smaller. In this embodiment, the Young's modulus of a SiO₂ film of the second oscillating plate 106 can be 80.6 GPa and the Young's modulus of a polyimide film of the first oscillating plate 110 can be 10.9 GPa. Accordingly, there is a difference of 69.7 GPa between the Young's moduli. A reason for this is explained below.

The inkjet head 1 according to this embodiment has a structure in which the actuator 102 is held between the second oscillating plate 106 and the first oscillating plate 110. If an electric field is applied to the actuator 102 and the actuator 102 expands in a direction orthogonal to an electric field direction, a force for deforming the second oscillating plate 106 to the ink pressure chamber 201 side in a concave shape is applied to the second oscillating plate 106. Conversely, a force for deforming the first oscillating plate 110 to the ink pressure chamber 201 side in a convex shape is applied to the first oscillating plate 110. If the actuator 102 contracts in a direction orthogonal to the electric field direction, a force for deforming the second oscillating plate 106 to the ink pressure chamber 201 side in a convex shape is applied to the second oscillating plate 106 and a force for deforming the first oscillating plate 110 to the ink pressure chamber 201 side in a concave shape is applied to the first oscillating plate 110. In other words, if the actuator 102 expands and contracts in the direction orthogonal to the electric field direction, forces for deforming the second oscillating plate 106 and the first oscillating plate 110 in exactly opposite directions are applied to the oscillating plates. Therefore, if the thicknesses and Young's modulus of the second oscillating plate 106 and the first oscillating plate 110 are the same, even if a voltage is applied to the actuator 102, since the forces for deforming the second oscillating plate 106 and the first oscillating plate 110 in exactly opposite directions by the same amount are applied to the oscillating plates, the nozzle plate 100 is not deformed. Therefore, the ink is not ejected.

In this embodiment, the Young's modulus of the polyimide film of the first oscillating plate 110 can be smaller than the Young's modulus of the SiO₂ film of the second oscillating plate 106. Therefore, a deformation amount of first oscillating plate 110 can be larger with respect to the same force. In the structure of this embodiment, if the actuator 102 expands in a direction orthogonal to the electric field direction, the nozzle plate 100 is deformed to the ink pressure chamber 201 side in a convex shape and the volume of the pressure chamber 201 is reduced (because an amount of deformation of the first oscillating plate 110 to the ink pressure chamber 201 side in a convex shape is larger). Conversely, if the actuator 102 contracts in a direction orthogonal to the electric field direction, the nozzle plate 100 is deformed to the ink pressure chamber 201 side in a concave shape and the volume of the pressure chamber 201 is increased (because an amount of deformation of the first oscillating plate 110 to the ink pressure chamber 201 side in a concave shape is larger). Since the difference between the Young's modulus of the second oscillating plate 106 and the Young's modulus of the first oscillating plate 110 is larger, when the same voltage is applied to the actuator 102, the difference between deformation amounts of oscillating plates increases. Therefore, ink ejection can be performed under a lower voltage condition if the difference between the Young's modulus of the second oscillating plate 106 and the Young's modulus of the first oscillating plate 110 is larger.

As explained above, the deformation amount of the plate shape is affected by not only the Young's modulus of the plate material but also the thickness of the plate material. Therefore, if a deformation amount of the second oscillating plate 106 and a deformation amount of the first oscillating plate 110 are set differently, it can be necessary to take into account not only Young's modulus of materials but also thicknesses of the oscillating plates. Even if the Young's modulus of the second oscillating plate 106 and the Young's modulus of the first oscillating plate 110 are the same, if the thicknesses are different, ink ejection is possible, although under a high-voltage condition.

Besides, in selection of a material of the first oscillating plate 110, the selection is performed taking into account heat resistance, insulating properties (when ink having high electric conductivity is used, the influence of ink deterioration due to driving of the actuators 102 is taken into account), a coefficient of thermal expansion, smoothness, and wettability to ink.

The metal film 111 can be an aluminum film and can be formed on a polyimide film at thickness of 0.4 μm by a sputtering method. The metal film 111 can be used as a mask in dry-etching the first oscillating plate 110 and the second oscillating plate 106 explained later.

For the metal film 111, instead of aluminum, Cu, Ag, Ti, W, Mo, Pt, and Au can be used. Other formation methods for the metal film 111 that can be used can include CVD, vacuum deposition, metal plating, or the like. The thickness of the metal film 111 is desirably in a range of 0.01 μm to 1 μm.

In FIG. 5(g), the metal film 111 and the first oscillating plate 110 patterned into a shape suitable for the nozzle 101 and the wiring electrode terminal section 104 are shown. A method for this patterning is explained.

First, the metal film 111 is etched into a circular pattern shape having a diameter of about 20 μm for the nozzle 101 and a square pattern shape for the wiring electrode terminal section 104 and the shared electrode terminal section 105 shown in FIG. 3 using a photo resist and the etching method.

Subsequently, dry etching of the first oscillating plate 110 is performed using the patterned metal film 111 as a mask to form the circular pattern shape of the nozzle 101 and the square pattern shape of the wiring electrode terminal section 104 and the shared electrode terminal section 105 shown in FIG. 3.

In FIG. 5(h), the second oscillating plate 106 patterned into a shape suitable for the nozzle 101 is shown. The patterning of the second oscillating plate 106 is performed by dry etching using the metal film 111 and the wiring electrode 103 of the wiring electrode terminal section 104 as a mask. Since the wiring electrode 103 has an etching-gas resistance like the metal film 111, the second oscillating plate 106 under the wiring electrode terminal section 104 is not etched.

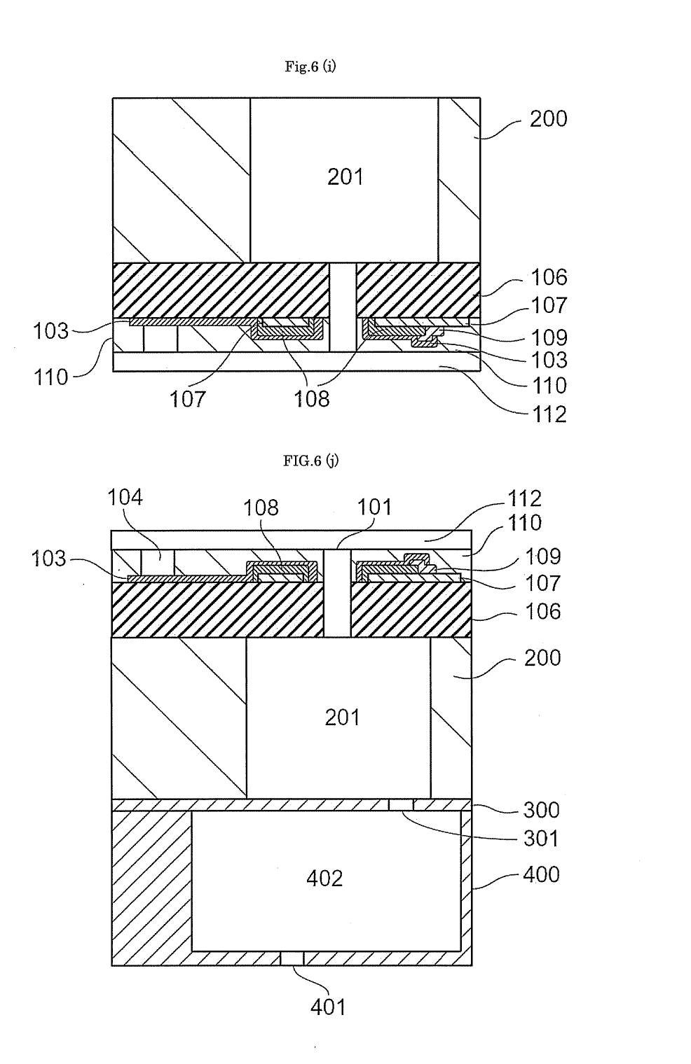

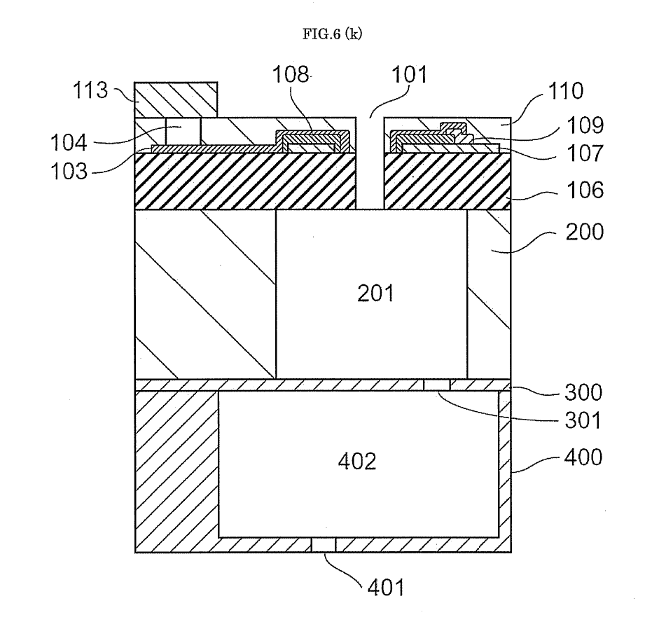

In FIG. 6(i), the ink pressure chamber 201 formed in the ink pressure chamber structure 200 by placing a first oscillating plate protecting tape 112 on the first oscillating plate 110 and vertically reversing the ink pressure chamber structure 200 is shown. The ink pressure chamber 201 has a columnar shape having a diameter of about 240 μm. The ink pressure chamber 201 is patterned such that the center position of the ink pressure chamber 201 and the center position of the nozzle 101 substantially coincide with one another. In FIG. 6(i), FIG. 5(h) is vertically reversed.

A patterning method for an ink pressure chamber is explained. After the metal film 111 shown in FIG. 5(h) is removed by etching, the first oscillating plate protecting tape 112 is placed. As the first oscillating plate protecting tape 112, a back protection tape for chemical mechanical polishing (CMP) for a silicon wafer can be used.

An etching mask is formed on the ink pressure chamber structure 200, which can be a silicon wafer having a thickness of 725 μm. The silicon wafer excluding the etching mask can be removed to form the ink pressure chamber 201 using a vertical deep drilling dry etching technique called Deep-RIE exclusive for a silicon substrate disclosed in WO2003/030239 filed by Sumitomo Precision Products Co., Ltd. The etching mask is formed by, after applying a photo resist on the ink pressure chamber structure 200, performing a pre-bake, exposing the photo resist using a mask on which a desired pattern is formed, and performing a post-bake through a development process.

For the Deep-RIE exclusive for a silicon substrate, SF₆ is used as an etching gas. However, the SF6 gas does not have an etching action on the SiO₂ film of the second oscillating plate 106 and the polyimide film of the first oscillating plate 110. Therefore, the progress of the dry etching of the silicon wafer forming the ink pressure chamber 201 is stopped by the second oscillating plate 106. In other words, the SiO₂ film of the second oscillating plate 106 plays the role of a stop layer for the Deep-RIE etching.

In the above explanation, as the etching method, a wet etching method in which a chemical is used and a dry etching method in which plasma is used are selected as appropriate. Fabrication is performed with the etching method and etching conditions changed according to materials of the insulating film, the electrode film, the piezoelectric film, and the like. After the etching by the photo resist films ends, the remaining photo resist films are removed by a solution.

In FIG. 6(j), a section of the separate plate 300 and the ink supply path structure 400 bonded to the ink pressure chamber structure 200 is shown. The separate plate 300 and the ink supply path structure 400 are bonded by an epoxy resin. After the separate plate 300 and the ink supply path structure 400 are bonded, the separate plate 300 is bonded to the ink pressure chamber structure 200.

In a section shown in FIG. 6(k), an electrode terminal section cover tape is placed on the wiring electrode terminal section 104 of the first oscillating plate 110. After bonding strength of the first oscillating plate protecting tape 112 is reduced to peel the first oscillating plate protecting tape 112 by performing ultraviolet ray irradiation from the first oscillating plate protecting tape 112 side shown in FIG. 14J, an electrode terminal section cover tape 113 is placed on a region of the wiring electrode terminal section 104 and the shared electrode terminal section 105 shown in FIG. 3. This cover tape can be made of resin. The bonding strength of the cover tape can be equivalent to the bonding strength of cellophane tape that can be easily stuck and peeled. The electrode terminal section cover tape 113 is stuck for the purpose of preventing adhesion of dust to the wiring electrode terminal section 104 and the shared electrode terminal section 105 and adhesion of a repellent ink film 114 during formation of the repellent ink film 114 explained later.

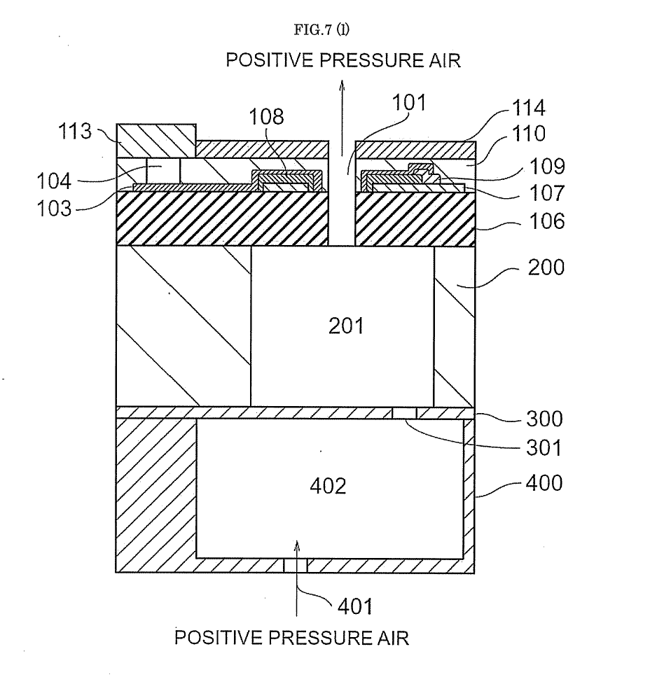

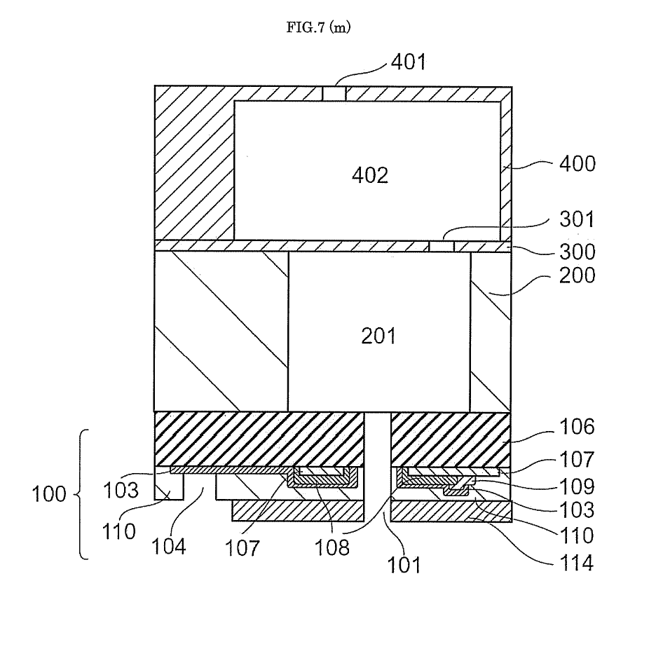

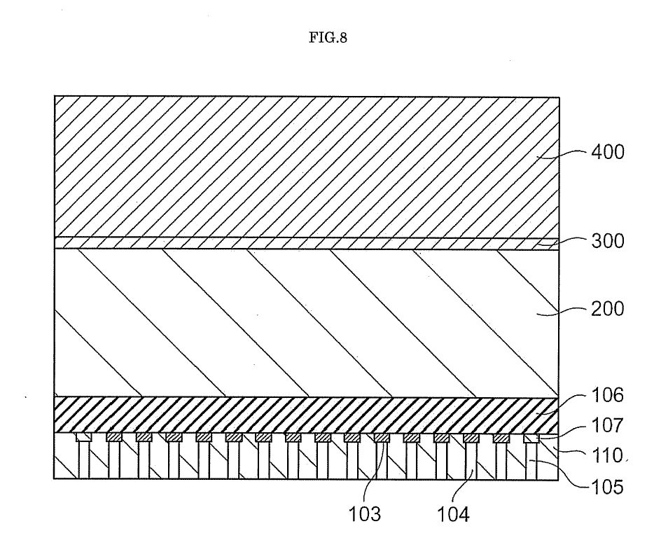

In a section shown in FIG. 7(l), a repellent ink film 114 is formed on the first oscillating plate 110 excluding the inner wall of the nozzle 101. A material used for the repellent ink film 114 can be a silicone repellent fluid material or a fluorine-containing organic material having fluid repellency. In the present invention, CYTOP, which is a commercially-available fluorine-containing organic material, manufactured by Asahi Glass Co., Ltd. can be used. The thickness of the repellent ink film 114 is about 1 μm.

The repellent ink film 114 can be formed by spin-coating a repellent ink material in a fluid state on the first oscillating plate 110. In this spin coating, positive-pressure air is injected from the ink supply path 402 simultaneously with the fixing of the inkjet head 1. Consequently, positive pressure air is discharged from the nozzle 101 connected to the ink supply path 402. If the repellent ink film material in a fluid state is applied in this state, the repellent ink film material does not adhere to an ink channel on the inner wall of the nozzle 101 and the repellent ink film 114 is formed only on the first oscillating plate 110.

A section of the manufactured inkjet head 1 is shown in FIG. 7(m). The ink is supplied from the ink supply port 401 provided in the ink supply path structure 400 to the ink supply path 402. The ink in the ink supply path 402 flows to the ink pressure chambers 201 via the ink supply chokes 301 and is filled in the nozzles 101. The ink supplied from the ink supply port 401 is kept at appropriate negative pressure. The ink in the nozzles 101 is kept without leaking from the nozzles 101.

FIG. 8 is a section of the wiring electrode terminal section 104 and the shared electrode terminal section 105 corresponding to B-B′ shown in FIG. 3. The first oscillating plate 110 is etched only in the wiring electrode terminal section 104 and the shared electrode terminal section 105. The repellent ink film 114 is not formed on the first oscillating plate 110.

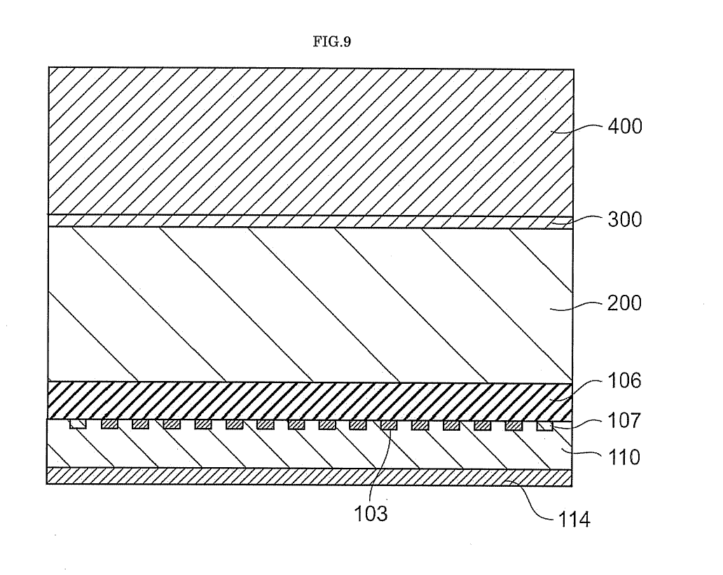

FIG. 9 is a section of the wiring section of the wiring electrode 103 and the shared electrode 107 corresponding to C-C′ shown in FIG. 3. Unlike FIG. 8, the first oscillating plate 110 is formed on a wire and the repellent ink film 114 is formed on the first oscillating plate 110.

### Second Embodiment

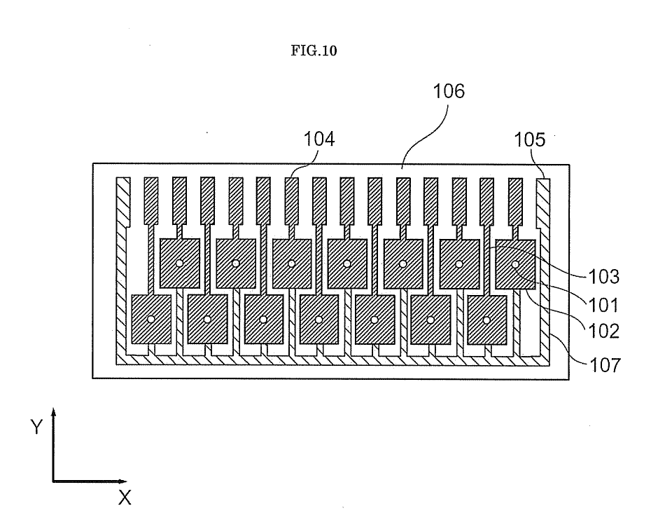

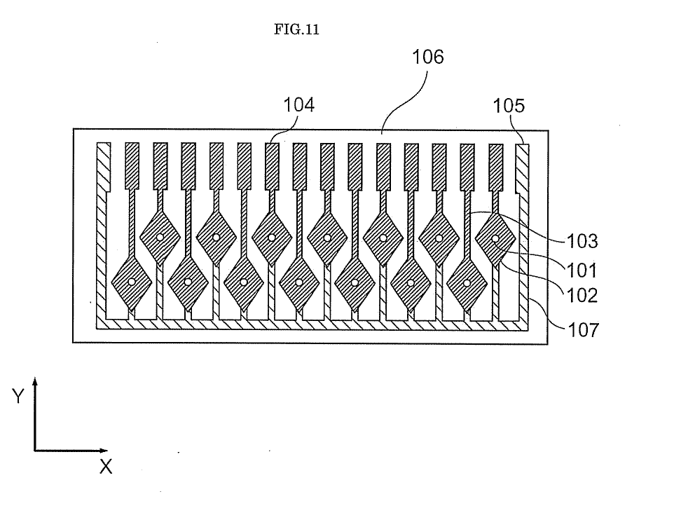

The inkjet head 1 according to a second embodiment is shown in FIG. 10. The shape of the actuator 102 is different from that in the first embodiment. The other components are the same as those in the first embodiment.

The actuator 102 is formed in a rectangular shape having width of about 170 μm and length of about 340 μm. The diameter of the nozzle 101 can be set to about 20 μm. The shape of the ink pressure chamber 201 is also a rectangular shape according to the shape of the actuator 102.

Compared with the circular piezoelectric film pattern, since the actuator 102 can be as large as 340 μm in the length direction, an actuator configured to eject the ink can be long. Therefore, it is possible to increase ink ejection pressure.

### Third Embodiment

The inkjet head 1 according to a third embodiment is shown in FIG. 11. The shape of the actuator 102 is different from that in the first embodiment. The other components are the same as those in the first embodiment.

The actuator 102 is formed in a rhomboid shape having a width of about 170 μm and length of about 340 μm. The diameter of the nozzle 101 can be set to about 20 μm. The shape of the ink pressure chamber 201 is also a rhomboid shape according to the shape of the actuator 102.

Compared with the circular piezoelectric film pattern, it is possible to arrange a piezoelectric pattern at higher density.

The several embodiments of the present invention are explained above. However, these embodiments are presented as examples and are not intended to limit the scope of the invention. These new embodiments can be carried out in other various forms. Various kinds of omission, replacement, and change can be performed without departing from the spirit of the invention. These embodiments and modifications thereof are included in the scope and the spirit of the invention and include in the inventions described in claims and a scope of equivalents of the inventions.

What is claimed is:

1. An inkjet head comprising:
a nozzle plate in which a nozzle having an ejection hole for ink is formed;
an ink pressure chamber for supplying the ink to the nozzle;
a first oscillating plate formed to surround the ejection hole of the nozzle of the nozzle plate;
a first electrode formed to surround the nozzle of the nozzle plate, the first electrode is in contact with the first oscillating plate;
a piezoelectric film configured to surround the nozzle of the nozzle plate, the piezoelectric film is in contact with the first electrode;
a second electrode formed to surround the nozzle of the nozzle plate, the second electrode is in contact with the piezoelectric film or the first oscillating plate; and
a second oscillating plate formed to surround the nozzle of the nozzle plate, the second oscillating plate is in contact with the first electrode, the second electrode, or the first oscillating plate.

2. The inkjet head according to claim 1, wherein a Young's modulus of the first oscillating plate and a Young's modulus of the second oscillating plate are different.

3. The inkjet head according to claim 1, wherein
a plurality of the nozzles are formed in the nozzle plate, and
the first electrode is an individual electrode provided to eject the ink from each of the nozzles.

4. The inkjet head according to claim 3, wherein the first electrode includes:
a plurality of electrode terminals to which a driving signal is externally supplied;
a plurality of wiring electrodes connected to the plurality of electrode terminals; and
a plurality of actuator wiring electrodes formed at ends of the plurality of wiring electrodes and configured to cover the piezoelectric film.

5. The inkjet head according to claim 1, wherein the first oscillating plate and the second oscillating plate are formed of an insulating material.

6. The inkjet head according to claim 1, wherein the first oscillating plate is formed of a resin material.

7. A method of manufacturing an inkjet head comprising:
forming a nozzle plate including:
forming a second oscillating plate on a substrate;
forming a second electrode on the second oscillating plate and fabricating the second electrode into a predetermined shape;
forming a piezoelectric film on the second oscillating plate and the second electrode and fabricating the piezoelectric film into a predetermined shape;
forming a first electrode on the second oscillating plate and the piezoelectric film and fabricating the first electrode into a predetermined shape;
forming a first oscillating plate on the second oscillating plate, the second electrode, and the first electrode and fabricating the first oscillating plate into a predetermined shape; and
fabricating the second oscillating plate into a predetermined shape; and
forming an ink pressure chamber by opening a hole in the substrate from an opposite side of the nozzle plate.
